(19) United States
(12) Patent Application Publication
(10) Pub. No.: US 2016/0350860 A1
(43) Pub. Date: Dec. 1, 2016

(54) MODIFYING AN ESTIMATED FINANCIAL PLAN

(71) Applicant: Bank of America Corporation, Charlotte, NC (US)

(72) Inventors: Katherine Dintenfass, Charlotte, NC (US); David M. Grigg, Rock Hill, SC (US); Alicia C. Jones-McFadden, Fort Mill, SC (US); Jeanne Ferullo Connolly, Braintree, MA (US); Craig Terrill, Barrington Hills, IL (US); Sahil Bahri, Chicago, IL (US); Sonny Tai, Chicago, IL (US); Markondapatnaikuni Samba Siva Patnaik, Chicago, IL (US)

(21) Appl. No.: 14/723,362

(22) Filed: May 27, 2015

(51) Int. Cl. G06Q 40/06

(52) U.S. Cl. CPC G06Q 40/06

(57) ABSTRACT

Embodiments of the invention are directed to systems, computer program products, and methods for modifying an estimated financial plan based on customer input. Embodiments access an estimated retirement plan comprising an estimated retirement date and an estimated retirement dollar amount; determine an estimated retirement plan confidence score; identify one or more external customer accounts; access one or more internal customer accounts; determine, based at least in part on the one or more external customer accounts and the one or more internal customer accounts, at least one likely customer account; present an inquiry to the customer requesting confirmation that the customer owns an additional customer account corresponding to the at least one likely customer account; and receive confirmation from the customer that the customer owns an additional customer account corresponding to the at least one likely customer account.

### FIELD

In general, embodiments of the invention relate to generating a one-click financial plan and implementing the plan upon user confirmation.

### BACKGROUND

Many people have not considered their financial situation upon retirement, or if they have done so, they have not implemented a plan to achieve the retirement they desire. Some obstacles to doing so are the time resources that may be necessary to have a professionally crafted, individually-tailored retirement plan prepared.

### BRIEF SUMMARY

Embodiments of the present invention address the above needs and/or achieve other advantages by providing apparatuses (e.g., a system, computer program product, and/or other device) and methods for modifying an estimated financial plan based on customer input.

According to embodiments of the invention, a system includes one or more memory devices; and one or more processing devices operatively coupled to the one or more memory devices, wherein the one or more processing devices are configured to execute computer-readable program code to access an estimated retirement plan comprising an estimated retirement date and an estimated retirement dollar amount; determine an estimated retirement plan confidence score; identify one or more external customer accounts; access one or more internal customer accounts; determine, based at least in part on the one or more external customer accounts and the one or more internal customer accounts, at least one likely customer account; present an inquiry to the customer requesting confirmation that the customer owns an additional customer account corresponding to the at least one likely customer account; and receive confirmation from the customer that the customer owns an additional customer account corresponding to the at least one likely customer account.

In some embodiments, the one or more processing devices are further configured to execute computer-readable program code to determine a set of outflow data comprising data corresponding to a plurality of debits originating from one or more accounts owned by the customer; determine a set of inflow data comprising data corresponding to a plurality of credits applied to one or more accounts owned by the customer; and wherein identifying the one or more external customer accounts is based at least in part on the set of outflow data and the set of inflow data.

In some embodiments, the one or more processing devices are further configured to execute computer-readable program code to determine that the estimated retirement plan is based in part on at least one unknown account; present a second inquiry to the customer requesting confirmation that the customer owns a second additional customer account corresponding to the at least one likely customer account; receive confirmation from the customer that the customer owns a second additional customer account corresponding to the at least one likely customer account; modify the estimated retirement plan confidence score based on the received confirmation; and present the modified estimated retirement plan confidence score to the customer.

In some embodiments, the one or more processing devices are further configured to execute computer-readable program code to determine that the estimated retirement plan is based in part on at least one unknown account; present a second inquiry to the customer requesting confirmation that the customer owns a second additional customer account corresponding to the at least one likely customer account; receive input from the customer indicating that the customer does not own a second additional customer account corresponding to the at least one likely customer account; modify the estimated retirement plan; modify the estimated retirement plan confidence score based on the received input; and present the modified estimated retirement plan confidence score to the customer.

In some embodiments, the one or more processing devices are further configured to execute computer-readable program code to request customer confirmation of an estimated retirement date; receive customer input indicating confirmation of the estimated retirement data; modify the estimated retirement plan confidence score based on the received input; and present the modified estimated retirement plan confidence score to the customer.

In some embodiments, the one or more processing devices are further configured to execute computer-readable program code to request customer confirmation of an estimated retirement date; receive customer input indicating a new retirement date different than the estimated retirement data; modify the estimated retirement plan; modify the estimated retirement plan confidence score based on the received input; and present the modified estimated retirement plan confidence score to the customer.

In some embodiments, the one or more processing devices are further configured to execute computer-readable program code to request customer confirmation of an estimated retirement amount; receive customer input indicating confirmation of the estimated retirement amount; modify the estimated retirement plan confidence score based on the received input; and present the modified estimated retirement plan confidence score to the customer.

In some embodiments, the one or more processing devices are further configured to execute computer-readable program code to request customer confirmation of an estimated retirement amount; receive customer input indicating a new retirement amount different than the estimated retirement amount; modify the estimated retirement plan; modify the estimated retirement plan confidence score based on the received input; and present the modified estimated retirement plan confidence score to the customer.

In some embodiments, the one or more processing devices are further configured to execute computer-readable program code to request customer confirmation of an estimated customer risk tolerance; receive customer input indicating confirmation of the estimated customer risk tolerance; modify the estimated retirement plan confidence score based on the received input; and present the modified estimated retirement plan confidence score to the customer.

In some embodiments, the one or more processing devices are further configured to execute computer-readable program code to request customer confirmation of an estimated customer risk tolerance; receive customer input indicating a new customer risk tolerance different than the estimated customer risk tolerance; modify the estimated retirement plan; modify the estimated retirement plan confidence score based on the received input; and present the modified estimated retirement plan confidence score to the customer.

According to embodiments of the invention, a computer program product for modifying an estimated financial plan based on customer input includes at least one non-transitory computer-readable medium having computer-readable program code portions embodied therein. The computer-readable program code portions include an executable portion configured to access an estimated retirement plan comprising an estimated retirement date and an estimated retirement dollar amount; an executable portion configured to determine an estimated retirement plan confidence score; an executable portion configured to identify one or more external customer accounts; an executable portion configured to access one or more internal customer accounts; an executable portion configured to determine, based at least in part on the one or more external customer accounts and the one or more internal customer accounts, at least one likely customer account; an executable portion configured to present an inquiry to the customer requesting confirmation that the customer owns an additional customer account corresponding to the at least one likely customer account; and an executable portion configured to receive confirmation from the customer that the customer owns an additional customer account corresponding to the at least one likely customer account.

In some embodiments, the computer-readable program code portions further comprise an executable portion configured to determine a set of outflow data comprising data corresponding to a plurality of debits originating from one or more accounts owned by the customer; an executable portion configured to determine a set of inflow data comprising data corresponding to a plurality of credits applied to one or more accounts owned by the customer; and wherein identifying the one or more external customer accounts is based at least in part on the set of outflow data and the set of inflow data.

In some embodiments, the computer-readable program code portions further comprise an executable portion configured to determine that the estimated retirement plan is based in part on at least one unknown account; an executable portion configured to present a second inquiry to the customer requesting confirmation that the customer owns a second additional customer account corresponding to the at least one likely customer account; an executable portion configured to receive confirmation from the customer that the customer owns a second additional customer account corresponding to the at least one likely customer account; an executable portion configured to modify the estimated retirement plan confidence score based on the received confirmation; and an executable portion configured to present the modified estimated retirement plan confidence score to the customer.

In some embodiments, the computer-readable program code portions further comprise an executable portion configured to determine that the estimated retirement plan is based in part on at least one unknown account; an executable portion configured to present a second inquiry to the customer requesting confirmation that the customer owns a second additional customer account corresponding to the at least one likely customer account; an executable portion configured to receive input from the customer indicating that the customer does not own a second additional customer account corresponding to the at least one likely customer account; an executable portion configured to modify the estimated retirement plan; an executable portion configured to modify the estimated retirement plan confidence score based on the received input; and an executable portion configured to present the modified estimated retirement plan confidence score to the customer.

In some embodiments, the computer-readable program code portions further comprise an executable portion configured to request customer confirmation of an estimated retirement date; an executable portion configured to receive customer input indicating confirmation of the estimated retirement data; an executable portion configured to modify the estimated retirement plan confidence score based on the received input; and an executable portion configured to present the modified estimated retirement plan confidence score to the customer.

In some embodiments, the computer-readable program code portions further comprise an executable portion configured to request customer confirmation of an estimated retirement date; an executable portion configured to receive customer input indicating a new retirement date different than the estimated retirement data; an executable portion configured to modify the estimated retirement plan; an executable portion configured to modify the estimated retirement plan confidence score based on the received input; and an executable portion configured to present the modified estimated retirement plan confidence score to the customer.

In some embodiments, the computer-readable program code portions further comprise an executable portion configured to request customer confirmation of an estimated retirement amount; an executable portion configured to receive customer input indicating confirmation of the estimated retirement amount; an executable portion configured to modify the estimated retirement plan confidence score based on the received input; and an executable portion configured to present the modified estimated retirement plan confidence score to the customer.

In some embodiments, the computer-readable program code portions further comprise an executable portion configured to request customer confirmation of an estimated retirement amount; an executable portion configured to receive customer input indicating a new retirement amount different than the estimated retirement amount; an executable portion configured to modify the estimated retirement plan; an executable portion configured to modify the estimated retirement plan confidence score based on the received input; and an executable portion configured to present the modified estimated retirement plan confidence score to the customer.

In some embodiments, the computer-readable program code portions further comprise an executable portion configured to request customer confirmation of an estimated customer risk tolerance; an executable portion configured to receive customer input indicating confirmation of the estimated customer risk tolerance; an executable portion configured to modify the estimated retirement plan confidence score based on the received input; and an executable portion configured to present the modified estimated retirement plan confidence score to the customer.

In some embodiments, the computer-readable program code portions further comprise an executable portion configured to request customer confirmation of an estimated customer risk tolerance; an executable portion configured to receive customer input indicating a new customer risk tolerance different than the estimated customer risk tolerance; an executable portion configured to modify the estimated retirement plan; an executable portion configured to modify the estimated retirement plan confidence score based on the received input; and an executable portion configured to present the modified estimated retirement plan confidence score to the customer.

According to embodiments of the invention, a method for modifying an estimated financial plan based on customer input includes accessing an estimated retirement plan comprising an estimated retirement date and an estimated retirement dollar amount; determining an estimated retirement plan confidence score; identifying one or more external customer accounts; accessing one or more internal customer accounts; determining, based at least in part on the one or more external customer accounts and the one or more internal customer accounts, at least one likely customer account; presenting an inquiry to the customer requesting confirmation that the customer owns an additional customer account corresponding to the at least one likely customer account; and receiving confirmation from the customer that the customer owns an additional customer account corresponding to the at least one likely customer account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will be made to the accompanying drawings, where:

FIG. 1 presents a block diagram of a system environment, in accordance with embodiments of the present invention;

FIG. 2 illustrates a process flow for generating a one-click financial plan, in accordance with embodiments of the present invention;

FIG. 3 illustrates a process flow for generating a one-click financial plan, in accordance with embodiments of the present invention;

FIG. 4 illustrates a process flow for generating a one-click financial plan, in accordance with embodiments of the present invention;

FIG. 5 illustrates a process flow for modifying an estimated financial plan based on customer input, in accordance with embodiments of the present invention;

FIG. 6 illustrates a process flow for modifying an estimated financial plan based on customer input, in accordance with embodiments of the present invention;

FIG. 7 illustrates a process flow for modifying an estimated financial plan based on customer input, in accordance with embodiments of the present invention; and

FIGS. 8A-8F illustrate screenshots of a customer application, in accordance with embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, a “user(s)” described herein may be a customer of a financial institution (e.g., an account holder or a person who has an account, such as a demand deposit account or investment account, is looking to open an account, or generally has any type of account with the financial institution for a good or service (e.g., product)). In one aspect, a user 4 may be any financial institution customer or any other affiliates associated with the financial institution. In some embodiments, the user 4 may be an individual who may be interested in opening an account with the financial institution. In some other embodiments, a user 4 may be any individual who may be interested in receiving financial information from a an associate 8 through the financial institution. For purposes of this invention, the term “user” and “customer” may be used interchangeably.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. In other embodiments, an “entity” may not be a financial institution.

An “account” may be the relationship that the user has with the entity. Examples of accounts include a deposit account, such as a transactional account (e.g. a banking account), a savings account, an investment account, a money market account, a time deposit, a demand deposit account, a pre-paid account, a credit account, a non-monetary user profile that includes only personal information associated with the user, or the like. The account is associated with and/or maintained by an entity.

As used herein, a “user interface” may be a graphical user interface. Typically, a graphical user interface (GUI) is a type of interface that allows users 4 to interact with electronic devices such as graphical icons and visual indicators such as secondary notation, as opposed to using only text via the command line. In some embodiments, the graphical user interface may include both graphical elements and text elements.

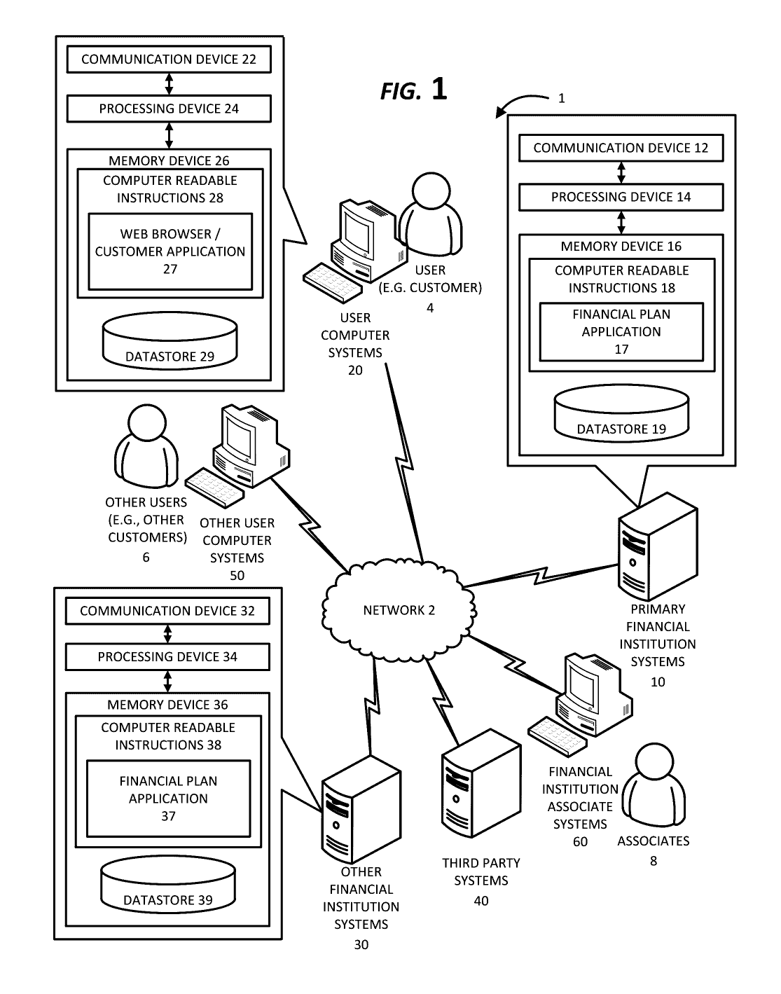

FIG. 1 illustrates a system environment 1, in accordance with an embodiment of the present invention. As illustrated in FIG. 1, one or more primary financial institution systems 10 are operatively coupled, via a network 2, to one or more user computer systems 20, one or more other financial institution systems 30, one or more third-party systems 40, one or more other user computer systems 50, one or more financial institution associate systems 60, and/or other like systems. In this way a user 4 (e.g., a customer of the primary financial institution) may utilize the user computer systems 20 to access the financial plan application 17 on the primary financial institution systems 10 to communicate with other users 6 through the other user computer systems 50 and the financial institution associate systems 60 to provide and exchange transaction information over the system environment 1. In some embodiments of the invention the primary financial institution systems 10 and/or the one or more other financial institution systems 30 may store account applications, transaction applications, demographic profile information, user profile information, and investment account information for the users 4, 6, and thus, the financial institution and the associates 8 within the financial institution may interact with the networked customers 4, 6.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 1, the primary financial institution systems 10 generally comprise a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device 14 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 14 may include functionality to operate one or more software programs based on computer-readable instructions 18 thereof, which may be stored in a memory device 16.

The processing device 14 uses the communication device 12 to communicate with the network 2 and other devices on the network 2, such as, but not limited to, the user computer systems 20, the other financial institution systems 30, third-party systems 40, other user computer systems 50, financial institution associate systems 60, and/or other like systems. As such, the communication device 12 generally comprises a modem, server, or other device for communicating with other devices on the network 2.

As further illustrated in FIG. 1, the primary financial institution systems 10 comprise computer-readable instructions 18 stored in the memory device 16, which in one embodiment includes the computer-readable instructions 18 of a financial plan application 17. In some embodiments, the memory device 16 includes a datastore 19 for storing data related to the financial institution systems 10, including, but not limited to, data created and/or used by the financial plan application 17.

The financial plan application 17 may be a tool, website, mobile device app, widget or the like that is used to aggregate inflow and outflow data corresponding to a particular customer, to generate a one-click financial plan, to calculate a plan confidence score, to modify the plan based on customer input, and/or for other tasks described herein.

As illustrated in FIG. 1, a user 4 may access the financial plan application 17 through a user computer system 20. The user computer system 20 may be a desktop, laptop, tablet, mobile device (e.g., smartphone device), or any other type of computer that generally comprises a communication device 22, a processing device 24, and a memory device 26.

The processing device 24 is operatively coupled to the communication device 22, and the memory device 26. The processing device 24 uses the communication device 22 to communicate with the network 2 and other devices on the network 2, such as, but not limited to, the primary financial institution systems 10, the other financial institution systems 30, the third-party systems 40, the other user computer systems 50, the financial institution associate systems 60, and/or other systems. As such, the communication device 22 generally comprises a modem, server, or other device for communicating with other devices on the network 2 and/or a keypad, keyboard, touch-screen, touchpad, display, microphone, mouse, joystick, other pointer device, button, soft key, and/or other input and/or output device(s) for communicating with the user 4.

As illustrated in FIG. 1, the user computer systems 20 may have computer-readable instructions 28 stored in the memory device 26, which in one embodiment includes the computer-readable instructions 28 of a web browser or customer application 27 that allows the user 4 to communicate with the financial plan application 17, or access or receive information from other applications, such as financial plan application 37, third-party applications, financial advisor applications, or the like. In some embodiments, the memory device 26 includes a datastore 29 for storing data related to the user computer systems 20, including but not limited to data created, received, and/or used by the web browser/application 27. The web browser/application 27 may be an application that allows the user 4 to access websites over a distributed network of systems (e.g., servers), such as the Internet or an intranet. The application 27 may also be a dedicated application for a computer or mobile device that allows the user 4 to access information over the distributed network of systems (e.g., servers), such as the Internet or an intranet.

As illustrated in FIG. 1, the financial institution systems 30 generally comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the primary financial institution systems 10, the user computer systems 20, third-party systems 40, other user computer systems 50, financial institution associate systems 60, and/or other systems. As such, the communication device 32 generally comprises a modem, server, or other device for communicating with other devices on the network 2.

As further illustrated in FIG. 1, the financial institution systems 30 comprise computer-readable instructions 38 stored in the memory device 36, which in one embodiment includes the computer-readable instructions 38 of financial plan application 37. In some embodiments, the memory device 36 includes a datastore 39 for storing data related to the other financial institution systems 30, including but not limited to data created and/or used by the financial plan application 37.

The financial plan application 37 may include information about the user's income, accounts, net worth, investments, personal user profile information (e.g., age, dependents, or the like), investment strategies, asset allocation, or other like information. In some embodiments, the financial institution may access this information for the user 4, or the user 4 may access this information directly, in order to provide information to the financial plan application 17. For example, in some embodiments of the invention, the financial plan application 17 does not communicate with other financial institution systems 30, but rather infers and estimates based on transaction and demographic data already known to the financial institution. However, in other embodiments, some or all of the inferred or estimated information may be confirmed by the other financial institution systems. In some embodiments, some or all the inferred or estimated information is confirmed by the customer herself or himself. In yet other embodiments, the other financial institution systems provide information related to or corresponding to the customer without the primary financial institution system making a related inference or estimation. For example, in some embodiments, the financial plan application 17 queries the financial plan application 37 to inquire whether Customer A has any accounts with the other financial institution system(s) 30. This query need not include any particular inference or estimate (e.g., that the customer has a checking account and a savings account at the other financial institution(s)).

The third-party systems 40, the other user computer systems 50, the financial institution associate systems 60, and/or other systems (not illustrated) are operatively coupled to the primary financial institution systems 10, user computer systems 20, and other financial institution systems 30, through the network 2. The third-party systems 40, the other user computer systems 50, the financial institution associate systems 60, and/or other systems may have devices the same as or similar to the devices described for the primary financial institution systems 10, the user computer systems 20, and the financial account systems 30 (e.g., communication device, processing device, memory device with computer-readable instructions, datastore, or the like). Thus, the third-party systems 40, the other user computer systems 50, the financial institution associate systems 60, and/or other systems communicate with the primary financial institution systems 10, the user computer systems 20, and the other financial institution systems 30, and/or each other in the same or similar way as previously described with respect to the primary financial institution systems 10, the user computer systems 20, and the other financial institution systems 30. The third-party systems 40, the other user computer systems 50, the financial institution associate systems 60, and/or other systems, in some embodiments, provide additional information about the users 4 or the other users 6, such as but not limited to users' profile information, the users' assets and liabilities, users' investments, or the like that is stored by the primary financial institution or other financial institutions, which may be used by the financial plan application 17, or the like.

In some embodiments of the invention, one or more of the systems may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the financial plan application 17 may be stored on the user computer systems 20, other user computer systems 50, or financial institution associate systems 60, in order to achieve the invention described herein (e.g., a mobile banking app stored on a mobile device of the users 4, 6).

According to embodiments of the invention, a system uses account inflow and/or outflow data (i.e., transaction data) available to a financial institution to determine an estimated financial plan corresponding to a customer of the financial institution. The estimated financial plan may include an estimated retirement amount (in dollars) necessary for the customer to retire and may also include an estimated retirement date. These characteristics or pieces of the estimated financial plan may be based solely on the inflow data, the outflow data or both and they may also be based on other information available to the financial institution such as personal information associated with the customer. This personal information may include the customer's age, marital status, how many children the customer has and their ages, the customer's net worth, information regarding the customer's assets (either maintained by the financial institution or elsewhere), information regarding the customer's liabilities (either maintained by the financial institution or elsewhere), information corresponding to the customer's insurance policies, information corresponding to the customer's mortgage(s), information corresponding to the customer's retirement account(s) and/or the like. In some cases, the account may be maintained by the financial institution (FI), in which case the FI has access to all the transactions associated with the account, and in other cases, the account may be maintained by another FI or other entity, in which case the FI may have access to none, some or all the transactions associated with the account. In such a case, the FI may make one or more assumptions about the external account.

For example, if a regular payment is made from a customer's checking account to an external account of a large amount (e.g., $1000), then the FI may assume the payment is a mortgage payment. The date the regular payments began may be determined based on the transaction history of the checking account. The system makes an assumption regarding the length of the mortgage (e.g., it may be pre-set to assume the customer has a 30 year fixed mortgage or a 15 year fixed mortgage), and based on the starting date and the assumed length of the mortgage, the system calculates the final payment date. This information is factored into the estimated financial plan. For example, if the customer will be assumed to retire before the mortgage is paid off, then the remaining mortgage payments are factored into the estimated retirement plan. As another example, if the customer will be assumed to retire after the mortgage is paid off, then the customer will be assumed to have an additional monthly amount to contribute toward retirement once the mortgage has been paid off. Of course, the estimated retirement plan will also not include the mortgage payment in the estimated monthly liabilities if it has been paid off. Furthermore, the estimated retirement plan, in some embodiments, may consider property tax. For example, based on the location of the property, which may be known based on the customer's address, as well as the prevailing interest rates at the inception of the regular mortgage payments, the purchase price of the real estate may be estimated. Based on the publicly available property taxes, anticipated appreciation (or depreciation) of the property, and estimated appreciation (or depreciation) of property taxes, the property taxes for the customer at retirement may be estimated and factored into the estimated retirement plan.

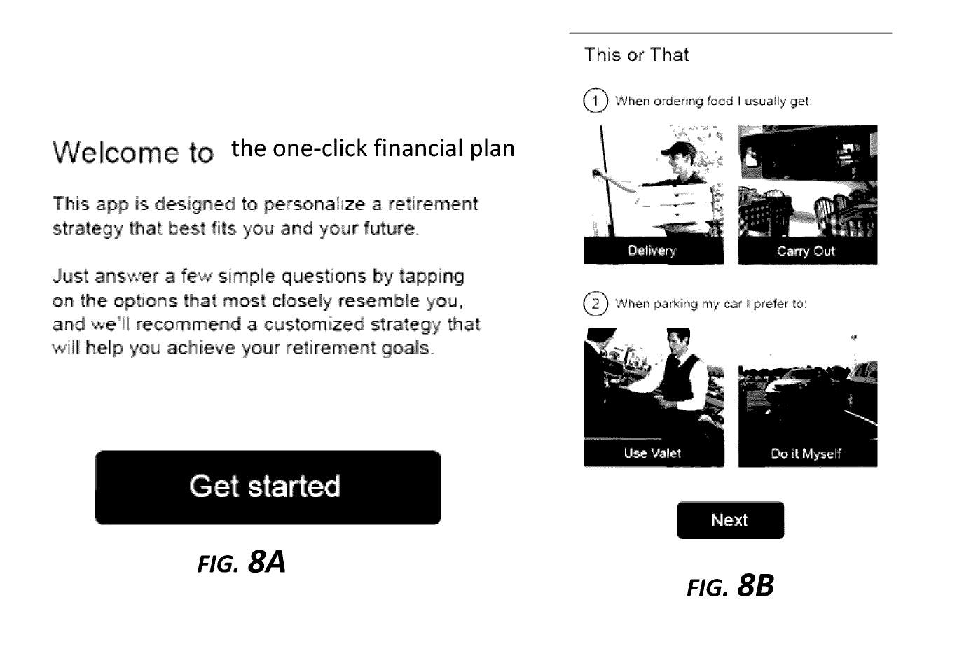

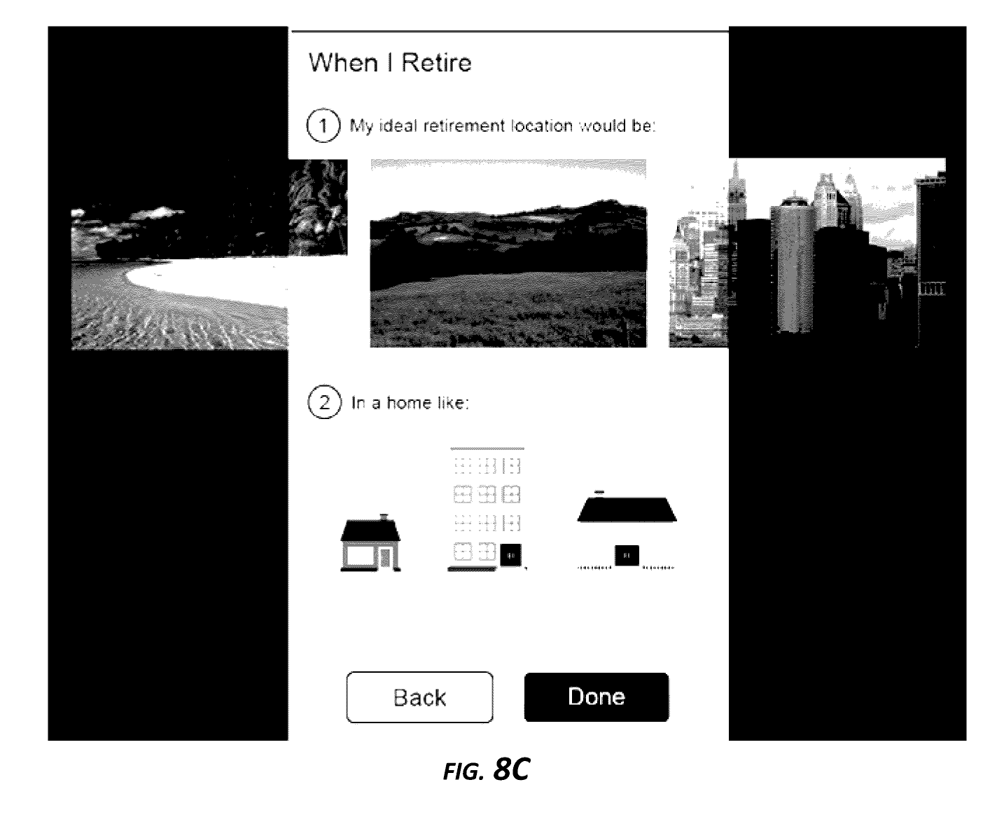

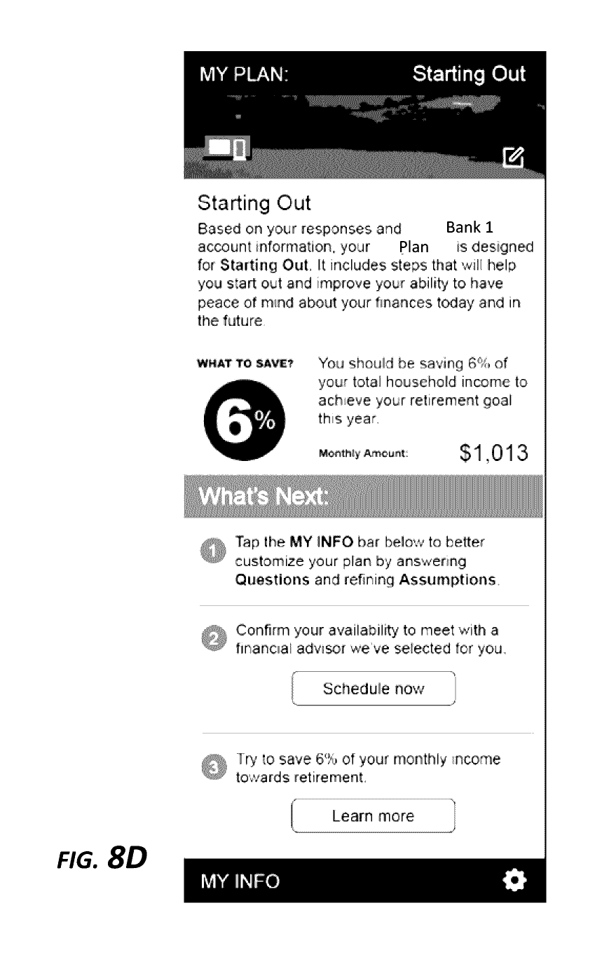

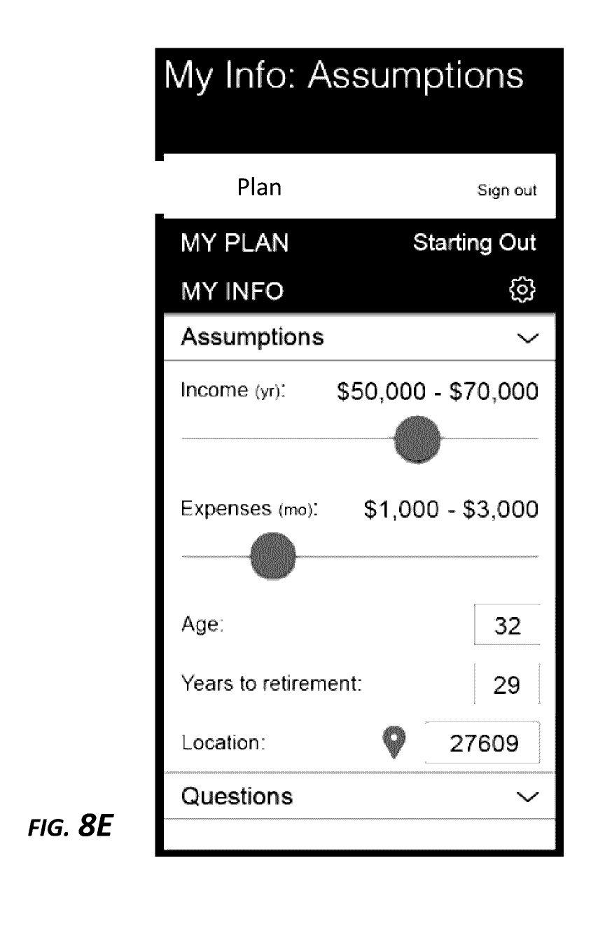

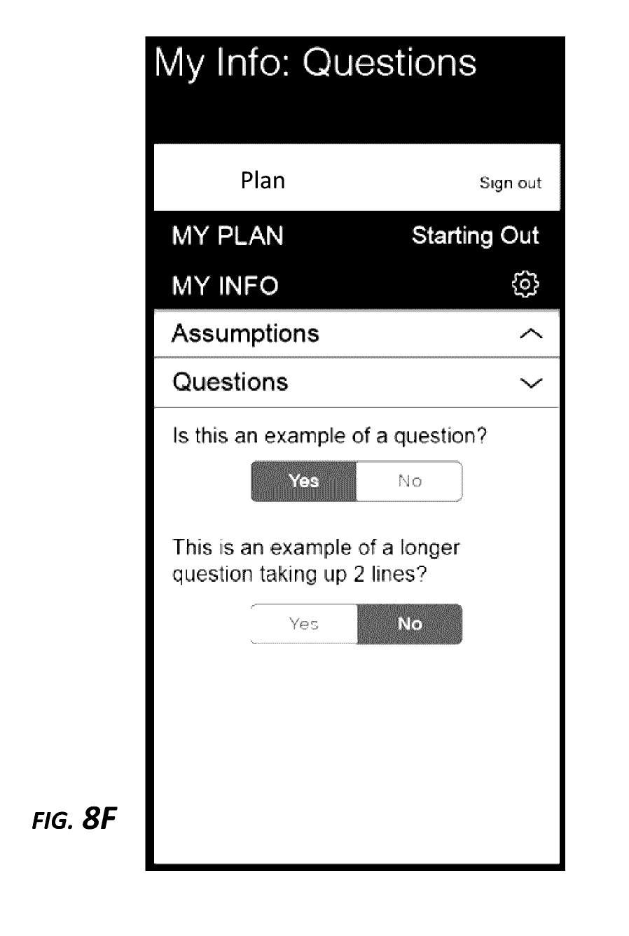

In some embodiments, the system asks one or more initial questions to gauge the spending habits of the customer as shown in the screenshots of FIG. 8. This information may also be assumed or implied based on the inflow and/or outflow data. In some cases, a confidence score is calculated regarding the estimated retirement plan and the score is presented to the customer. If the customer confirms certain information and/or answers certain questions, then the estimated retirement plan as well as the confidence score can be re-calculated. The more confirmations/questions the customer answers, the higher the confidence score. The more accounts of different types the customer maintains at the primary FI (which is facilitating the financial plan application 17), the higher the confidence score. In some embodiments, the system compares the customer to customers in a similar position using demographic data available to the FI. If other customers similarly situated to the customer have an average of two (2) car loans, but the customer's inflow/outflow data indicates the customer has no car loans, then the financial plan application 17 may assume the customer has two (2) car loans that are services by other FIs.

In some embodiments, when such as assumption is made, the financial plan application 17 presents an inquiry to the customer to confirm or deny the assumption. In some cases, the customer's answer leads to further questions. For example, if the customer is presented with such an inquiry but denies the customer has two (2) car loans, the application 17 follows up with a question asking the customer how many car loans the customer has. In other embodiments, such as a “one-click” financial plan embodiment, the application 17 makes various assumptions based on the data available to it, generated an estimated financial plan and then presents the estimated financial plan or some version of the estimated financial plan to the customer as a “one-click” financial plan. This one-click financial plan may be presented to the customer as an estimated monthly amount of money that needs to be saved for the customer to retire. The one-click financial plan may also be presented with an option for the customer to select to implement the plan. The application 17, when such an option is selected by the customer, may, in response, schedule a recurring transfer of the estimated monthly amount into a retirement account for the customer. In some cases, the customer may have the option to choose to answer some number of questions to further hone the estimated retirement plan to fit their actual situation (i.e., to remove assumptions may by the application 17). When the customer inputs information in response to such questions, then the assumptions may be considered fact (or not) and the confidence score regarding the estimated retirement plan may be increased.

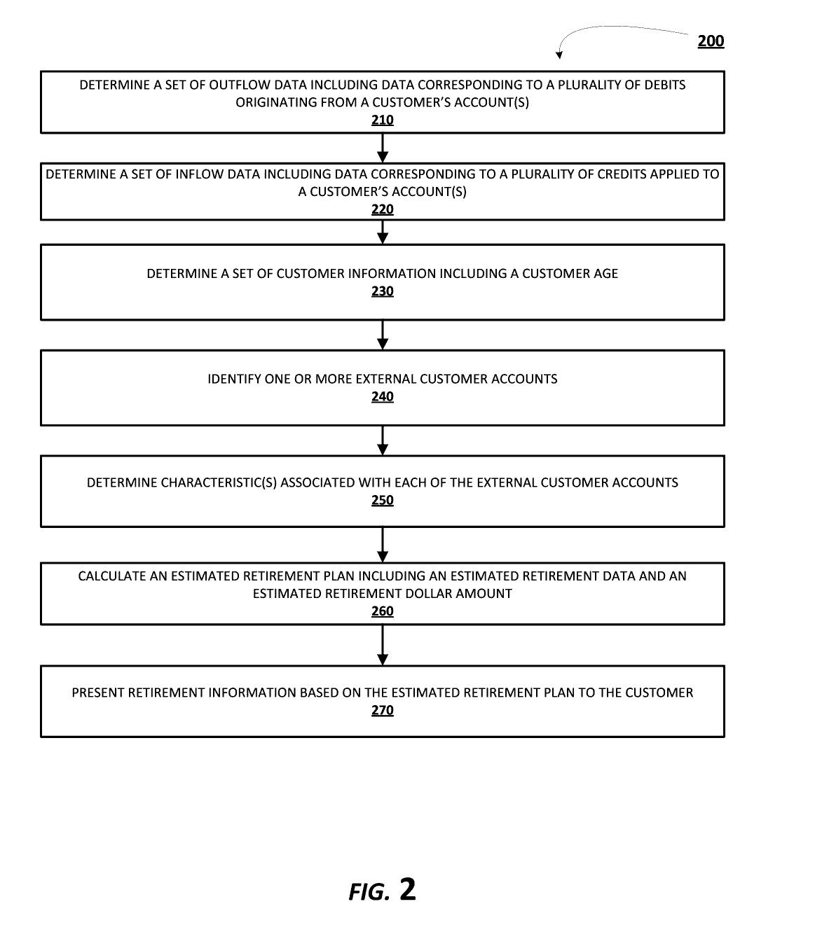

Referring now to FIG. 2, a flowchart illustrates a method 200 for generating a one-click financial plan 200. As illustrated in block 210 of FIG. 2, the primary financial institution system 10 uses the financial plan application 17 to determine a set of outflow data. The set of outflow data corresponds to debits originating from a customer's account(s) at the primary financial institution. The outflow data may include data such as a transaction amount and date, the merchant code associated with a transaction, identification of the account that was debited and the like. The outflow data may also include data resulting from calculations and/or combinations with other data. For example, the outflow data may be or include information indicating that a debit of a specific amount occurs monthly on a particular date to a particular recipient. The outflow data may also include information regarding expected future transactions based on historical transactions. These future transactions may be predicted by a processing device, such as processing device 14 running financial plan application 17.

As illustrated in block 220, the primary financial institution system 10 uses the financial plan application 17 to determine a set of inflow data. The inflow data corresponds to credits applied to a customer's account(s) at the primary financial institution. The inflow data may include data such as a transaction amount and date, identification of the originating entity and the account to which the credit was applied. The inflow data may also include data resulting from calculations and/or combinations with other data. For example, the inflow data may be or include information indicating that a credit of a specific amount occurs monthly on a particular data to a particular account and made from a particular sender. The inflow data may also include information regarding expected future transactions based on historical transactions. These future transactions may be predicted by a processing device, such as processing device 14 running financial plan application 17.

As illustrated in block 230, the financial plan application 17 determines a set of customer information. In various embodiments, the customer information includes different information related to or about the customer. For example, the customer information may include the customer's age, the customer's net worth, information about the customer's account(s) at the primary financial institution or the like. This information may be retrieved from a customer profile established by the customer in conjunction with the customer's online banking account and/or by the customer in conjunction with opening one or more accounts maintained by the FI.

As illustrated in block 240, the financial plan application 17 identifies one or more external customer accounts. This identification can be performed in several ways. For example, the application 17 may make one or more assumptions regarding the customer. For example, the application 17 may assume the customer has a mortgage if the customer is within a particular age range. The application may then 17 determine the average outstanding balance and time remaining for pay off of a similarly situated representative customer. In some cases, the customer is considered to be similar to a particular demographic set of people, and that demographic set of people's average numbers are used. The customer may be deemed similar to a group of people based on the customer's financial picture available to the FI. The external account(s) may also be identified by asking the customer whether the customer has any external accounts and received the customer's input regarding the account(s) if they exist. In another example, the external account(s) may be identified by querying one or more databases or other financial institutions to ask whether the customer has any account(s). In some cases, such an inquiry is preceded by approval from the customer to make such an inquiry and in some cases, the other financial institutions must have the customer's approval to release any information about the customer.

As illustrated in block 250, the financial plan application 17 determines characteristic(s) associated with each of the external customer accounts. The characteristics of the accounts may be determined based on asking the customer questions about the accounts and/or by making assumptions. The assumptions that are made may be made based on the financial data that is available to the FI and/or based on similarly situated customers.

As illustrated in block 260, the financial plan application 17 calculates an estimated retirement plan. The estimated retirement plan may include estimated retirement data and an estimated retirement dollar amount. The estimated retirement plan may be based on inflow data, outflow data or both. It may also be based on assumptions made regarding the customer such as other accounts and/or liabilities the customer may have based on the customer's spending/saving habits and/or other similarly situated customers. It may also be based on answers the customer provides to particular questions regarding the customer's saving habits, spending habits, retirement goals and the like.

As illustrated in block 270, the financial plan application 17 presents retirement information based on the estimated retirement plan to the customer. This retirement information may be or include the amount necessary for the customer to retire on a given date, the monthly amount necessary for the customer to save in order to be able to retire on the given date and/or other information.

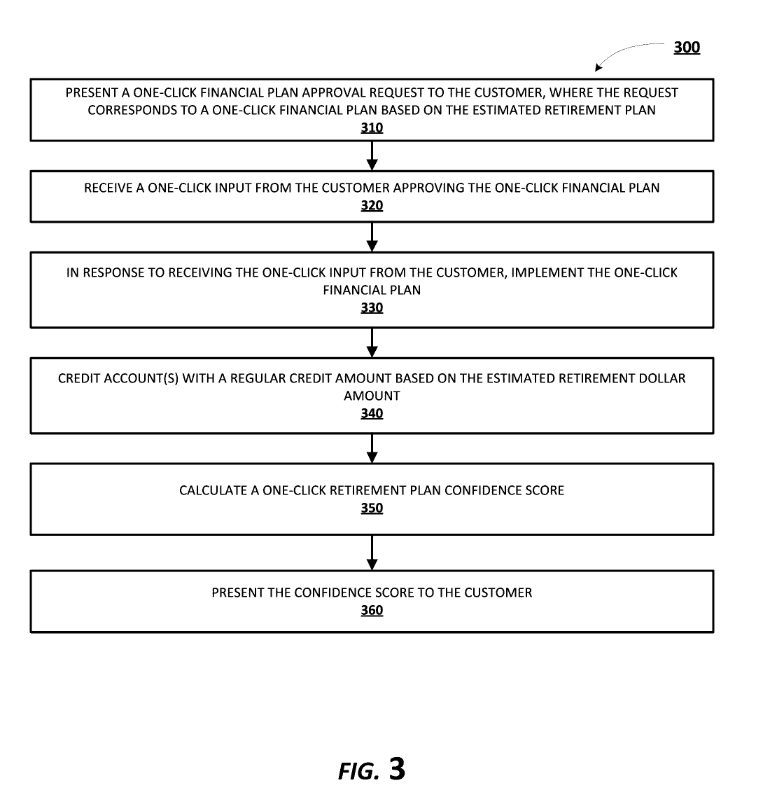

Referring now to FIG. 3, a flowchart illustrates a method 300 for generating a one-click retirement plan according to embodiments of the invention. As illustrated in block 310, the financial plan application 17 using the customer application 27, presents a one-click financial plan approval request to the customer. The request corresponds to a one-click financial plan based on the estimated retirement plan. In some embodiments, the retirement information is a so-called “one-click” financial plan that may indicate to the customer an estimated amount the customer needs to save every month in order to be able to retire. The one-click financial plan gives the customer an option to select to implement the plan. The implementation of the plan may include opening a retirement account and/or setting up a recurring transfer of funds to the retirement account in order to meet the monthly savings goal of the one-click financial plan.

As illustrated in block 320, the financial plan application 17 receives a one-click input from the customer. In the case where the user approves the one-click financial plan, the financial plan application 17 implements the one-click financial plan, as illustrated in block 330. The financial plan application 17 credits one or more accounts with a regular credit amount based on the estimated retirement dollar amount in some embodiments, as illustrated by block 340.

The financial plan application 17, in some embodiments, calculates a one-click retirement plan confidence score, as represented by block 350, and then presents the confidence score to the customer, as represented by block 360. The confidence score may be based on how many and what type of assumptions the application 17 had to make to arrive at the estimated financial plan. For example, the confidence score may have a baseline amount of 75/100, and when the customer answers a question that removes an assumption from the estimated financial plan, the confidence score increases to 80/100. If the customer answers a question that leads to further assumptions being necessary, however, the confidence score may actually go down. For example, if the customer indicates that the customer actually does have a mortgage when the application 17 assumed the customer had no mortgage and the customer does not provide any details regarding the mortgage, then the confidence score may go from 75/100 to 60/100. This large drop may be due to the fact that an assumption is being made regarding what is considered to be a significant account type, which in this case is a mortgage. For example, the account types, liability types and the like may be sorted into significance buckets. When the significance buckets are applied to the customer's information and assumptions, then the confidence score may be determined. As an example, if an assumption must be made regarding the customer's mortgage, then that assumption may be weighted higher in determining the confidence score than an assumption that is made regarding a car loan due to the varying expected financial impact of the assumptions.

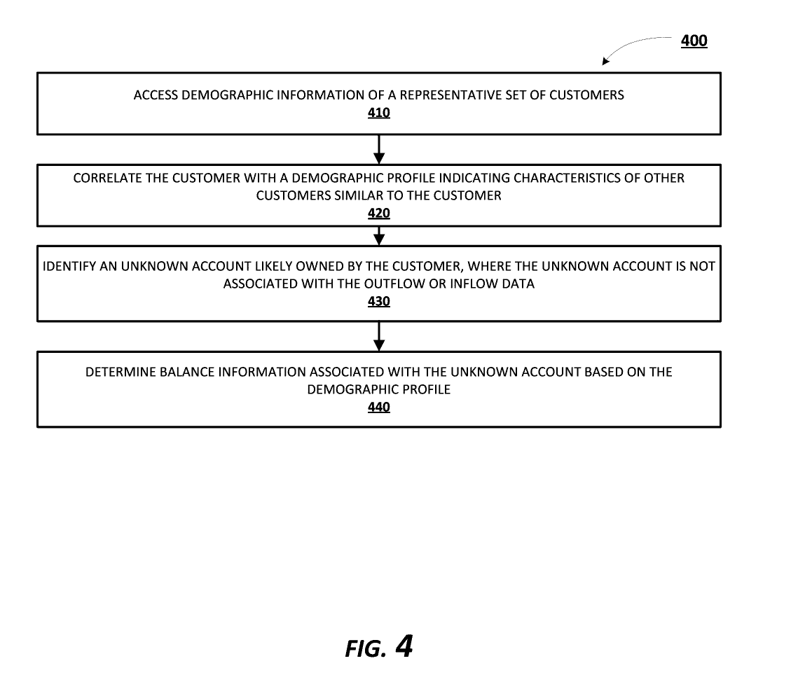

Referring now to FIG. 4, a flowchart illustrates a method for generating a one-click financial plan according to embodiments of the invention. In some embodiments, the financial plan application 17 accesses demographic information of a representative set of customers, as represented by block 410. Next, represented by block 420, the financial plan application 17 correlates the customer with a demographic profile indicating characteristics of other customer similar to the customer. These characteristics may then be used to make assumptions regarding the customer's financial picture. For example, if the other available data (e.g., inflow/outflow data) does not indicate the customer has student loans but the demographic profile does, then the application 17 may make the assumption the customer has student loans and present the customer with a question to confirm that the customer has student loans.

As illustrated by block 430, the financial plan application 17 identifies an unknown account likely owned by the customer in some embodiments. The unknown account is not associated with the set of outflow data or the set of inflow data, but rather, is a product of the demographic profile correlation. For example, the correlation of the customer with the demographic information produces the demographic profile that “predicts” what types of accounts similarly situated customers own and their characteristics, such as balances of the accounts. As illustrated by block 440, the financial plan application 17 determines balance information associated with the unknown account based on the demographic profile.

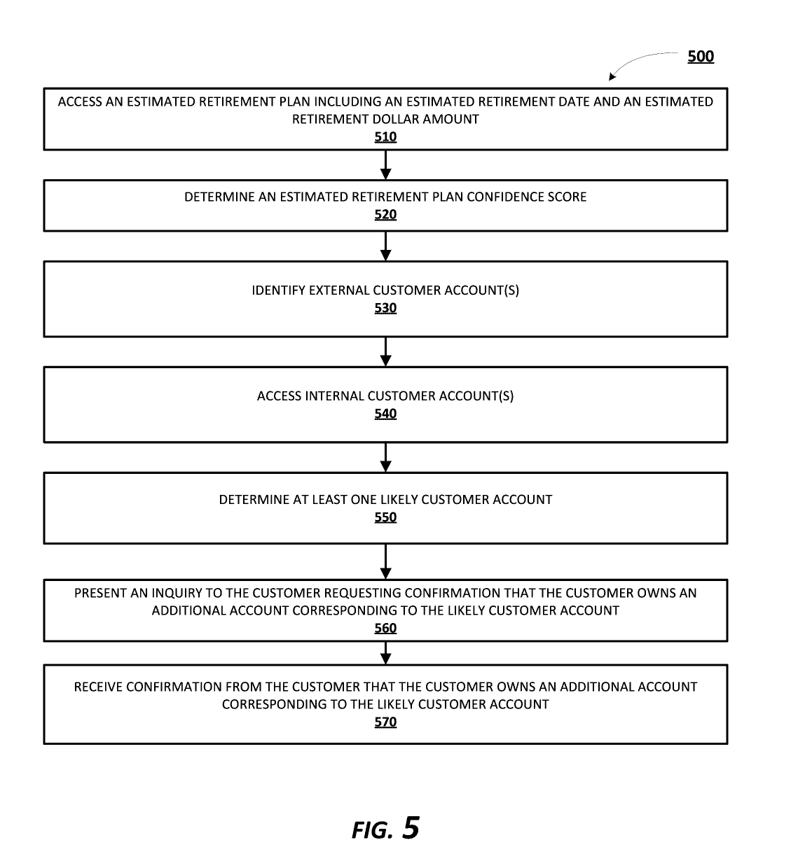

Referring now to FIG. 5, a flowchart illustrates a method 500 for modifying an estimated financial plan based on customer input, in accordance with embodiments of the invention. As illustrated by block 510, the financial plan application 17 accesses an estimated retirement plan. The estimated retirement plan, in some embodiments, includes an estimated retirement data and an estimated retirement dollar amount. As illustrated by block 520, the financial plan application 17 determines an estimated retirement plan confidence score as discussed above. As represented by block 530, the financial plan application 17 identifies external customer account(s) as discussed above. As represented by block 540, the financial plan application 17 accesses internal customer account(s). These account(s) may be accounts maintained by the primary FI or affiliates. As represented by block 550, the financial plan application 17 determines at least one likely (unknown) customer account, and then presents an inquiry to the customer requesting confirmation that the customer owns an additional account corresponding to the likely customer account, as represented by block 560. As represented by block 570, the financial plan application 17 receives confirmation from the customer that the customer owns an additional account corresponding to the likely customer account, in some embodiments. In other situations, of course, the customer may indicate that the customer does not own an additional account corresponding to the likely customer account.

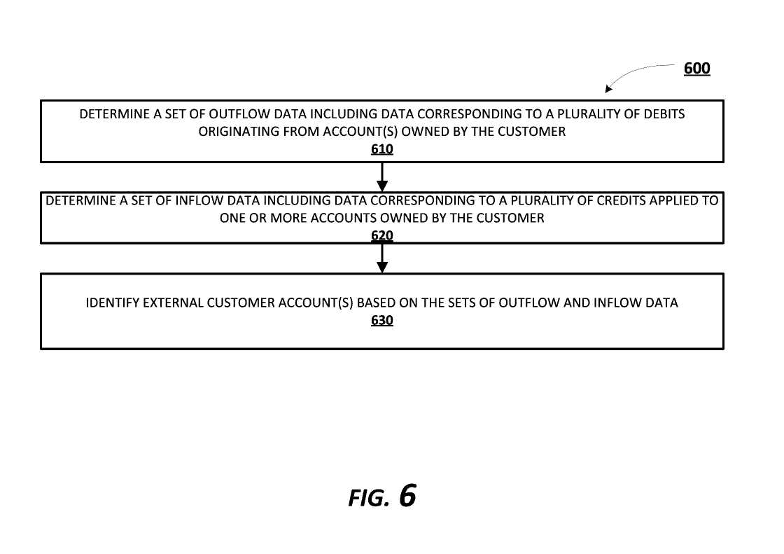

Referring now to FIG. 6, a flowchart illustrates a method 600 for modifying an estimated financial plan based on customer input. As represented by block 610, the financial plan application 17 determines a set of outflow data including data corresponding to a plurality of debits originating from account(s) owned by the customer. As illustrated by block 620, the financial plan application 17 determines a set of inflow data including data corresponding to a plurality of credits applied to one or more accounts owned by the customer. As represented by block 630, the financial plan application 17 identifies external customer account(s) based on the sets of outflow and inflow data.

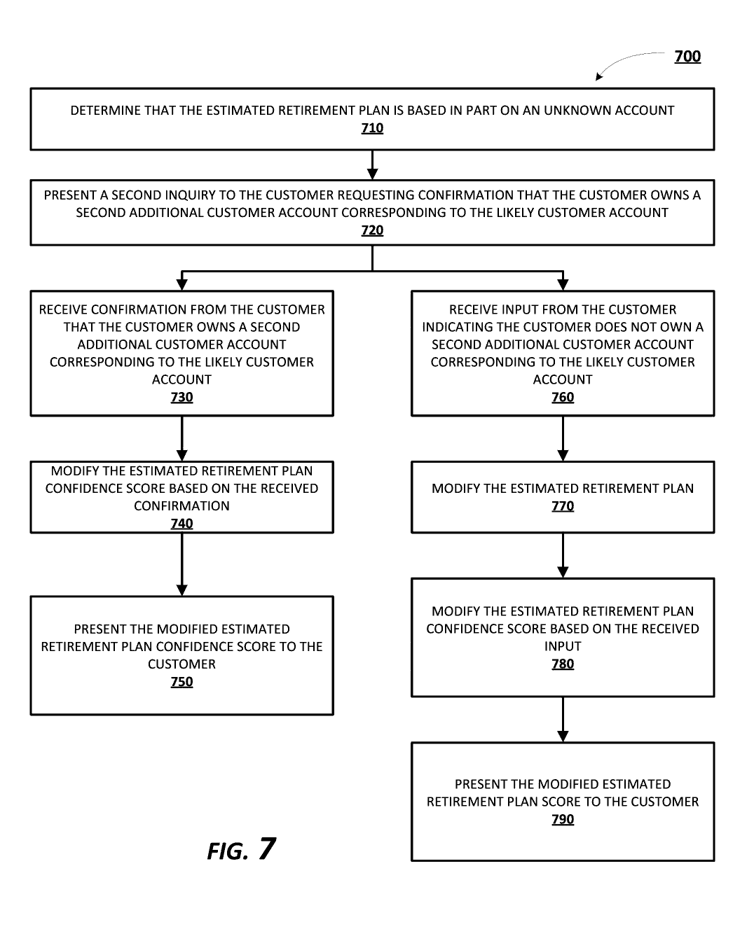

Referring now to FIG. 7, a flowchart illustrates a method 700 for modifying an estimated financial plan based on customer input. As represented by block 710, the financial plan application 17 determines that the estimated retirement plan is based in part on an unknown account. Next, as represented by block 720, the financial plan application 17 presents a second inquiry to the customer requesting confirmation that the customer owns a second additional customer account corresponding to the likely customer account.

As represented by block 730, in some instances, the financial plan application 17 receives confirmation from the customer that the customer owns a second additional customer account corresponding to the likely customer account. As represented by block 740, the financial plan application 17 modifies the estimated retirement plan confidence score based on the received confirmation. Finally, as represented by block 750, the financial plan application 17 presents the modified estimated retirement plan confidence score to the customer.

As represented by block 760, in other instances, the financial plan application 17 receives input from the customer indicating the customer does not own a second additional customer account corresponding to the likely customer account. As illustrated by block 770, the financial plan application 17 modifies the estimated retirement plan. As represented by block 780, the financial plan application 17 modifies the estimated retirement plan confidence score based on the received input. Finally, as represented by block 790, the financial plan application 17 presents the modified estimated retirement plan score to the customer.

Referring now to FIGS. 8A-8F, several diagrams illustrate representative screenshots of embodiments of the invention. FIG. 8A illustrates a screenshot of a one-click financial plan welcome page. This embodiment of the welcome page explains that the customer application 27 is designed to personalize a retirement strategy that best fits the customer's future. FIG. 8B illustrates a screenshot of representative questions presented to the customer. These questions are presented to the customer to gather information regarding the customer's preferences. For example, the questions shown inquire regarding the customer's preference for food and for parking. The customer's answers to these questions shed light on the customer's anticipated level of expense in retirement. FIG. 8C illustrates a screenshot of another question asking the customer their ideal retirement location and type of home. These questions further assist in determining the level of expense the customer will require in retirement. Based on the customer's answers to these questions and the inflow/outflow information available to the financial institution, the financial plan application 17 (or other application) can prepare an estimated financial plan.

As shown in FIG. 8D, a “starting out” plan is provided to the customer. In some embodiments (not shown), the customer is presented the estimated financial plan and is given an opportunity to implement the plan by providing a simple input, such as a single “click” of the mouse. An estimated plan implemented by a simple input such as this is referred to herein as a “one-click financial plan”. The one-click financial plan may be the estimated financial plan or may be based on some of the estimated financial plan.

As shown in FIG. 8D, the plan may be better customized to the customer by the customer answering additional questions and/or refining assumptions made about the customer. Also, the customer may schedule a meeting with a financial advisor or other financial institution associate. The application also provides the customer an opportunity to learn more about saving the estimated necessary amount the customer will need for retirement. In other embodiments (not shown), a specific “one-click implementation” is provided that enables the customer to select a simple input and automatically implement a plan to achieve the retirement goal. In the example shown, the savings goal of 6% of total household income may be implemented by automatically transferring the necessary amount from the customer's checking account every month into an account earmarked for retirement savings.

FIG. 8E shows a diagram illustrating follow up questions configured to assist in modifying an existing financial plan. The interface presents one or more of the assumptions made about the customer, such as the customer's annual income level, the customer's monthly expense amount, the customer's age, the number of years until the customer's desired retirement date, and the customer's location.

In various embodiments, implementation of the financial plan includes determining an appropriate investment allocation based on the customer's personal risk tolerance and/or timeframe until retirement. Once the investment allocation is determined, the various necessary accounts may be automatically opened as necessary and automatic payments into those accounts may be scheduled and/or made in order to reach retirement goals.

In some embodiments, a system makes a determination of the financial plan and determines what actions are necessary to implement the plan. For example, the system may determine that opening accounts is a necessary action, communicating alerts to the customer that the accounts will be opened automatically and requesting electronic signatures as necessary from the customer may be a necessary action and initiating one-time and/or automatic transactions for making deposits into appropriate accounts may be necessary. For one or more of these example necessary actions, the system may generate appropriate control signals for causing one or more non-collocated systems to perform specific steps necessary to perform the necessary actions. For example, regarding communicating alerts, the system may generate control signals and communicate the control signals to a communication system to push appropriate alerts to the customer. Similarly, with regard to automatically opening accounts, the system may generate control signals and send them to one or more disparate systems to initiate opening of accounts. The control signals may include one or more instruction sets specifically generated to cause the receiving system or computer to perform one or more steps, processes or actions that it, otherwise, would not perform.

In accordance with embodiments of the invention, the term “module” may be used herein with respect to a system, and may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, JAVA, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. Pat. | | |
|---|---|---|---|
| Docket Number | application Ser. No. | Title | Filed On |
| 6508US1.014033.2439 | | GENERATING A ONE-CLICK | Concurrently |
| | | FINANCIAL PLAN | Herewith |
| 6510US1.014033.2440 | | A SYSTEM FOR NETWORK | Concurrently |
| | | PAIRING OF INVESTORS AND | Herewith |
| | | ADVSIORS BASED ON | |
| | | INVESTOR INFORMATION | |
| | | ANALYTICS | |
| 6514US1.014033.2441 | | AUTOMATED FUND | Concurrently |
| | | REALLOCATION BASED ON | Herewith |
| | | GOAL PROGRESS | |
| 6515US1.014033.2442 | | AN INTEGRATED FINANCIAL | Concurrently |
| | | AND HEALTH MONITORING | Herewith |
| | | SYSTEM UTILIZING | |
| | | WEARABLE DEVICES | |
| 6518US1.014033.2444 | | GOAL GUARANTEE SYSTEM | Concurrently |
| | | | Herewith |

What is claimed is:

1. A system modifying an estimated financial plan based on customer input, the system comprising:
one or more memory devices; and
one or more processing devices operatively coupled to the one or more memory devices, wherein the one or more processing devices are configured to execute computer-readable program code to:
access an estimated retirement plan comprising an estimated retirement date and an estimated retirement dollar amount;
determine an estimated retirement plan confidence score;
identify one or more external customer accounts;
access one or more internal customer accounts;
determine, based at least in part on the one or more external customer accounts and the one or more internal customer accounts, at least one likely customer account;
present an inquiry to the customer requesting confirmation that the customer owns an additional customer account corresponding to the at least one likely customer account; and
receive confirmation from the customer that the customer owns an additional customer account corresponding to the at least one likely customer account.

2. The system of claim 1, wherein the one or more processing devices are further configured to execute computer-readable program code to:
determine a set of outflow data comprising data corresponding to a plurality of debits originating from one or more accounts owned by the customer;
determine a set of inflow data comprising data corresponding to a plurality of credits applied to one or more accounts owned by the customer; and
wherein identifying the one or more external customer accounts is based at least in part on the set of outflow data and the set of inflow data.

3. The system of claim 1, wherein the one or more processing devices are further configured to execute computer-readable program code to:
determine that the estimated retirement plan is based in part on at least one unknown account;
present a second inquiry to the customer requesting confirmation that the customer owns a second additional customer account corresponding to the at least one likely customer account;
receive confirmation from the customer that the customer owns a second additional customer account corresponding to the at least one likely customer account;
modify the estimated retirement plan confidence score based on the received confirmation; and
present the modified estimated retirement plan confidence score to the customer.

4. The system of claim 1, wherein the one or more processing devices are further configured to execute computer-readable program code to:
determine that the estimated retirement plan is based in part on at least one unknown account;
present a second inquiry to the customer requesting confirmation that the customer owns a second additional customer account corresponding to the at least one likely customer account;
receive input from the customer indicating that the customer does not own a second additional customer account corresponding to the at least one likely customer account;
modify the estimated retirement plan;
modify the estimated retirement plan confidence score based on the received input; and
present the modified estimated retirement plan confidence score to the customer.

5. The system of claim 1, wherein the one or more processing devices are further configured to execute computer-readable program code to:
request customer confirmation of an estimated retirement date;
receive customer input indicating confirmation of the estimated retirement data;
modify the estimated retirement plan confidence score based on the received input; and
present the modified estimated retirement plan confidence score to the customer.

6. The system of claim 1, wherein the one or more processing devices are further configured to execute computer-readable program code to:
request customer confirmation of an estimated retirement date;
receive customer input indicating a new retirement date different than the estimated retirement data;
modify the estimated retirement plan;
modify the estimated retirement plan confidence score based on the received input; and
present the modified estimated retirement plan confidence score to the customer.

7. The system of claim 1, wherein the one or more processing devices are further configured to execute computer-readable program code to:
request customer confirmation of an estimated retirement amount;
receive customer input indicating confirmation of the estimated retirement amount;
modify the estimated retirement plan confidence score based on the received input; and
present the modified estimated retirement plan confidence score to the customer.

8. The system of claim 1, wherein the one or more processing devices are further configured to execute computer-readable program code to:
request customer confirmation of an estimated retirement amount;
receive customer input indicating a new retirement amount different than the estimated retirement amount;
modify the estimated retirement plan;
modify the estimated retirement plan confidence score based on the received input; and
present the modified estimated retirement plan confidence score to the customer.

9. The system of claim 1, wherein the one or more processing devices are further configured to execute computer-readable program code to:
request customer confirmation of an estimated customer risk tolerance;
receive customer input indicating confirmation of the estimated customer risk tolerance;
modify the estimated retirement plan confidence score based on the received input; and
present the modified estimated retirement plan confidence score to the customer.

10. The system of claim 1, wherein the one or more processing devices are further configured to execute computer-readable program code to:
request customer confirmation of an estimated customer risk tolerance;
receive customer input indicating a new customer risk tolerance different than the estimated customer risk tolerance;
modify the estimated retirement plan;
modify the estimated retirement plan confidence score based on the received input; and
present the modified estimated retirement plan confidence score to the customer.

11. A computer program product for modifying an estimated financial plan based on customer input, comprising at least one non-transitory computer-readable medium having computer-readable program code portions embodied therein, the computer-readable program code portions comprising:
an executable portion configured to access an estimated retirement plan comprising an estimated retirement date and an estimated retirement dollar amount;
an executable portion configured to determine an estimated retirement plan confidence score;
an executable portion configured to identify one or more external customer accounts;
an executable portion configured to access one or more internal customer accounts;
an executable portion configured to determine, based at least in part on the one or more external customer accounts and the one or more internal customer accounts, at least one likely customer account;
an executable portion configured to present an inquiry to the customer requesting confirmation that the customer owns an additional customer account corresponding to the at least one likely customer account; and
an executable portion configured to receive confirmation from the customer that the customer owns an additional customer account corresponding to the at least one likely customer account.

12. The computer program product of claim 11, wherein the computer-readable program code portions further comprise:
an executable portion configured to determine a set of outflow data comprising data corresponding to a plurality of debits originating from one or more accounts owned by the customer;
an executable portion configured to determine a set of inflow data comprising data corresponding to a plurality of credits applied to one or more accounts owned by the customer; and
wherein identifying the one or more external customer accounts is based at least in part on the set of outflow data and the set of inflow data.

13. The computer program product of claim 11, wherein the computer-readable program code portions further comprise:
an executable portion configured to determine that the estimated retirement plan is based in part on at least one unknown account;
an executable portion configured to present a second inquiry to the customer requesting confirmation that the customer owns a second additional customer account corresponding to the at least one likely customer account;
an executable portion configured to receive confirmation from the customer that the customer owns a second additional customer account corresponding to the at least one likely customer account;
an executable portion configured to modify the estimated retirement plan confidence score based on the received confirmation; and
an executable portion configured to present the modified estimated retirement plan confidence score to the customer.

14. The computer program product of claim 11, wherein the computer-readable program code portions further comprise:
an executable portion configured to determine that the estimated retirement plan is based in part on at least one unknown account;
an executable portion configured to present a second inquiry to the customer requesting confirmation that the customer owns a second additional customer account corresponding to the at least one likely customer account;
an executable portion configured to receive input from the customer indicating that the customer does not own a second additional customer account corresponding to the at least one likely customer account;
an executable portion configured to modify the estimated retirement plan;
an executable portion configured to modify the estimated retirement plan confidence score based on the received input; and
an executable portion configured to present the modified estimated retirement plan confidence score to the customer.

15. The computer program product of claim 11, wherein the computer-readable program code portions further comprise:
an executable portion configured to request customer confirmation of an estimated retirement date;
an executable portion configured to receive customer input indicating confirmation of the estimated retirement data;
an executable portion configured to modify the estimated retirement plan confidence score based on the received input; and
an executable portion configured to present the modified estimated retirement plan confidence score to the customer.

16. The computer program product of claim 11, wherein the computer-readable program code portions further comprise:
an executable portion configured to request customer confirmation of an estimated retirement date;
an executable portion configured to receive customer input indicating a new retirement date different than the estimated retirement data;
an executable portion configured to modify the estimated retirement plan;
an executable portion configured to modify the estimated retirement plan confidence score based on the received input; and
an executable portion configured to present the modified estimated retirement plan confidence score to the customer.

17. The computer program product of claim 11, wherein the computer-readable program code portions further comprise:
an executable portion configured to request customer confirmation of an estimated retirement amount;
an executable portion configured to receive customer input indicating confirmation of the estimated retirement amount;
an executable portion configured to modify the estimated retirement plan confidence score based on the received input; and
an executable portion configured to present the modified estimated retirement plan confidence score to the customer.

18. The computer program product of claim 11, wherein the computer-readable program code portions further comprise:
an executable portion configured to request customer confirmation of an estimated retirement amount;
an executable portion configured to receive customer input indicating a new retirement amount different than the estimated retirement amount;
an executable portion configured to modify the estimated retirement plan;
an executable portion configured to modify the estimated retirement plan confidence score based on the received input; and
an executable portion configured to present the modified estimated retirement plan confidence score to the customer.

19. The computer program product of claim 11, wherein the computer-readable program code portions further comprise:
an executable portion configured to request customer confirmation of an estimated customer risk tolerance;
an executable portion configured to receive customer input indicating confirmation of the estimated customer risk tolerance;
an executable portion configured to modify the estimated retirement plan confidence score based on the received input; and
an executable portion configured to present the modified estimated retirement plan confidence score to the customer.

20. The computer program product of claim 11, wherein the computer-readable program code portions further comprise:
an executable portion configured to request customer confirmation of an estimated customer risk tolerance;
an executable portion configured to receive customer input indicating a new customer risk tolerance different than the estimated customer risk tolerance;
an executable portion configured to modify the estimated retirement plan;
an executable portion configured to modify the estimated retirement plan confidence score based on the received input; and
an executable portion configured to present the modified estimated retirement plan confidence score to the customer.

21. A method for modifying an estimated financial plan based on customer input, the method comprising:
accessing an estimated retirement plan comprising an estimated retirement date and an estimated retirement dollar amount;
determining an estimated retirement plan confidence score;
identifying one or more external customer accounts;
accessing one or more internal customer accounts;
determining, based at least in part on the one or more external customer accounts and the one or more internal customer accounts, at least one likely customer account;
presenting an inquiry to the customer requesting confirmation that the customer owns an additional customer account corresponding to the at least one likely customer account; and
receiving confirmation from the customer that the customer owns an additional customer account corresponding to the at least one likely customer account.
